(19) United States
(12) Patent Application Publication
(10) Pub. No.: US 2024/0119485 A1
(43) Pub. Date: Apr. 11, 2024

(54) SYSTEMS AND METHODS FOR MONETIZATION BASED ON AN AMOUNT OF SPEECH OF AN ARTIFICIAL INTELLIGENCE CHARACTER

(71) Applicant: MINDLOGIC INC., Seoul (KR)

(72) Inventors: Yongwoo KIM, Seoul (KR); Jinwook KIM, Seoul (KR)

(21) Appl. No.: 18/546,093

(22) PCT Filed: Jul. 22, 2022
(86) PCT No.: PCT/KR2022/010824

§ 371 Date: Aug. 10, 2023

(30) Foreign Application Priority Data
Jan. 28, 2022 (KR) 10-2022-0012870

(51) Int. Cl. G06Q 30/0273; G06Q 30/0241; H04L 51/02

(52) U.S. Cl. CPC G06Q 30/0273; G06Q 30/0277; H04L 51/02

(57) ABSTRACT

The present disclosure relates to a monetization method and system for compensating a creator owning an artificial intelligence (AI) character with a reward according to an amount of speech of the AI character and the method includes providing a conversation service between an AI character created by a creator and at least one follower that follows the AI character; determining an amount of speech of the AI character in the conversation service; and compensating the creator with a preset reward based on a determination result.

### CROSS-REFERENCE TO RELATED APPLICATION

This application is a U.S. National Phase Patent Application of International Patent Application Number PCT/KR2022/010824, filed on Jul. 22, 2022, which claims priority to Korean Patent Application Number 10-2022-0012870, filed on Jan. 28, 2022, the entire contents of which are hereby incorporated by reference.

### BACKGROUND

### 1. Field

Aspects of one or more embodiments of the present disclosure relate to systems and methods for monetization based on an amount of speech of an artificial intelligence (AI) character.

### 2. Description of Related Art

Artificial Intelligence (AI) is revolutionizing business, organization operation, lifestyle, and communication methods. Various informatization projects are being conducted to provide optimal services for fast-changing lifestyle of the modern culture and diverse and ever-changing requirements of customers. Among them, technology related to big data and deep learning has recently developed rapidly and AI technology applied to real life is implemented in certain fields and is being applied to an intelligent personal service that integrally provides and uses analysis related to specific data and information of various fields specialized for each individual. Currently, interaction between AI and humans is limited, but is performed in everyday natural language, that is, in a conversation form. Although it is still at a rudimentary stage, various home appliances connected to a network may be controlled through a conversation method using voice and a search for specific information, a query, and a response may be performed based on knowledge to which deep learning is applied.

The above information disclosed in this Background section is for enhancement of understanding of the background of the present disclosure, and therefore, it may contain information that does not constitute prior art.

### SUMMARY

An objective of the present disclosure is to provide a monetization method and system that may provide a revenue (or compensation) to a creator that creates an artificial intelligence (AI) character using a conversation service through the AI character.

Here, technical subjects to be solved by the present disclosure are not limited to the aforementioned subjects and may variously expand without departing from technical spirit and scope of the present disclosure.

A monetization method according to an amount of speech of an artificial intelligence (AI) character according to an example embodiment of the present disclosure includes providing a conversation service between an AI character created by a creator and at least one follower that follows the AI character; determining an amount of speech of the AI character in the conversation service; and compensating the creator with a reward (e.g., a preset reward) based on a determination result.

The determining may include accumulating an amount of speech for a conversation message amount (speech) input from the AI character that participates in the conversation service.

The compensating may include compensating the creator with an additional reward that is applied according to an increase in a level of the AI character.

The compensating may include compensating the creator by applying the reward (e.g., the preset reward) that regularly increases according to the amount of speech of the AI character when the number of times (or the number of sessions) the AI character participated in the conversation service or the number of conversations with a specific follower is greater than or equal to a criterion or a threshold (e.g., a preset criterion or a preset threshold). In other words, in some embodiments, the creator is compensated by increasing the reward based on a number of times the AI character participates in the conversation service being greater than or equal to a threshold and/or based on a number of conversations with a specific follower being greater than or equal to a threshold.

The compensating may include compensating the creator by applying the reward (e.g., the preset reward) that regularly increases according to the amount of speech of the AI character when specific requirements that include at least one of a level of the AI character and the number of followers are met.

The compensating may include compensating the creator with a reward that is set as (e.g., that is based on) a revenue distribution according to (e.g., associated with) at least one of a number of AI characters, the amount of speech of the AI character, a number of followers, and a preference of the followers, based on advertising revenue and fund size for monetization.

Also, the monetization method according to the amount of speech of the AI character according to an example embodiment of the present disclosure may further include providing advertising information based on (e.g., when) providing the conversation service between the AI character and the follower. The compensating may include compensating the creator with the reward (e.g., the preset reward) based on (e.g., according to) a provision of the advertising information (e.g., based on the advertising information being provided).

A monetization system according to an amount of speech of an AI character according to an example embodiment of the present disclosure includes a conversation provider configured to provide a conversation service between an AI character created by a creator and at least one follower that follows the AI character; a determiner configured to determine an amount of speech of the AI character in the conversation service; and a compensator configured to compensate the creator with a reward (e.g., a preset reward) based on a determination result.

The determiner may be configured to accumulate an amount of speech for a conversation message amount (speech) input from the AI character that participates in the conversation service.

The compensator may be configured to compensate the creator with an additional reward that is applied according to an increase in a level of the AI character.

The compensator may be configured to compensate the creator by applying the reward (e.g., the preset reward) that regularly increases according to the amount of speech of the AI character when the number of times (or the number of sessions) the AI character participates in the conversation service or the number of conversations with a specific follower is greater than or equal to a criterion (e.g., a preset criterion).

The compensator may be configured to compensate the creator by applying a reward (e.g., a preset reward) that regularly increases according to the amount of speech of the AI character when specific requirements that include at least one of a level of the AI character and the number of followers are met.

The compensator may be configured to compensate the creator with a reward that is set as a revenue distribution according to at least one of the number of AI characters, the amount of speech of the AI character, the number of followers, and a preference by the followers (e.g., a preference of the followers), based on advertising revenue and fund size for monetization.

Also, the monetization system according to the amount of speech of the AI character according to an example embodiment of the present disclosure may further include a controller configured to provide advertising information when providing the conversation service between the AI character and the follower. The compensator may be configured to compensate the creator with the reward (e.g., the preset reward) according to provision of the advertising information.

An AI character conversation service method according to an example embodiment of the present disclosure includes providing a conversation service between an AI character created by a creator and at least one follower that follows the AI character; and providing advertising information from the AI character to the follower through a conversation between the AI character and the follower.

According to an example embodiment of the present disclosure, it is possible to provide a creator that creates an artificial intelligence (AI) character with a revenue (or compensation) according to an activity of the AI character by compensating the creator with a reward (e.g., a preset reward) according to an amount of speech of the AI character in a conversation service using the AI character that performs a conversation with a follower.

Here, effects of the present disclosure are not limited to the aforementioned effects and may variously expand without departing from technical spirit and scope of the present disclosure.

The above and other aspects and features of the present disclosure will become better understood through the accompanying drawings, the detailed description, and the claims and their equivalents.

### BRIEF DESCRIPTION OF DRAWINGS

Non-limiting and non-exhaustive embodiments of the present disclosure are described with reference to the following figures, wherein like reference numerals refer to like parts throughout the various views unless otherwise specified.

FIG. 1 illustrates an example of a network environment, according to some embodiments of the present disclosure.

FIG. 2 is a diagram illustrating an example of an internal configuration of an electronic device and a server of FIG. 1, according to some embodiments of the present disclosure.

FIG. 3 is a flowchart illustrating a monetization method according to an amount of speech of an artificial intelligence (AI) character, according to some embodiments of the present disclosure.

FIG. 4 is a flowchart according to an example embodiment for operation S320 of FIG. 3, according to some embodiments of the present disclosure.

FIG. 5 illustrates an example of a method of determining an amount of speech of an AI character, according to some embodiments of the present disclosure.

FIG. 6 is a diagram illustrating a configuration of a monetization system according to an amount of speech of an AI character, according to some embodiments of the present disclosure.

FIG. 7 is a flowchart illustrating an AI character conversation service method, according to some embodiments of the present disclosure.

FIG. 8 is a flowchart according to an example embodiment for operation S720 of FIG. 7, according to some embodiments of the present disclosure.

FIG. 9 illustrates an example of describing a method of providing an advertising service, according to some embodiments of the present disclosure.

FIG. 10 is a diagram illustrating a configuration of an AI character conversation service system, according to some embodiments of the present disclosure.

### DETAILED DESCRIPTION

Aspects of the present disclosure and methods of accomplishing the same may be understood more readily by reference to the detailed description of one or more embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey aspects of the present disclosure to those skilled in the art. Accordingly, description of processes, elements, and techniques that are not necessary to those having ordinary skill in the art for a complete understanding of the aspects and features of the present disclosure may be omitted.

Unless otherwise noted, like reference numerals, characters, or combinations thereof denote like elements throughout the attached drawings and the written description, and thus, descriptions thereof will not be repeated. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown to facilitate a less obstructed view of these various embodiments and to make the description clear.

In the detailed description, for the purposes of explanation, numerous specific details are set forth to provide a thorough understanding of various embodiments. It is apparent, however, that various embodiments may be practiced without these specific details or with one or more equivalent arrangements.

It will be understood that, although the terms “zeroth,” “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or component is referred to as being “on,” “connected to,” or “coupled to” another element or component, it can be directly on, connected to, or coupled to the other element or component, or one or more intervening elements or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or component is referred to as being “between” two elements or components, it can be the only element or component between the two elements or components, or one or more intervening elements or components may also be present.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, each of the terms “or” and “and/or” includes any and all combinations of one or more of the associated listed items. For example, the expression “A and/or B” denotes A, B, or A and B.

For the purposes of this disclosure, expressions such as “at least one of,” when preceding a list of elements, modify the entire list of elements and do not modify the individual elements of the list. For example, “at least one of X, Y, or Z,” “at least one of X, Y, and Z,” and “at least one selected from the group consisting of X, Y, and Z” may be construed as X only, Y only, Z only, or any combination of two or more of X, Y, and Z, such as, for instance, XYZ, XYY, YZ, and ZZ.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

When one or more embodiments may be implemented differently, a specific process order may be performed differently from the described order. For example, two consecutively described processes may be performed substantially at the same time or performed in an order opposite to the described order.

Any of the components or any combination of the components described (e.g., in any system diagrams included herein) may be used to perform one or more of the operations of any flow chart included herein. Further, (i) the operations are merely examples, and may involve various additional operations not explicitly covered, and (ii) the temporal order of the operations may be varied.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Aspects of one or more embodiments of the present disclosure relate to systems and methods for monetization based on an amount of speech of an artificial intelligence (AI) character and more particularly, technology for compensating a creator that owns an AI character with a reward according to an amount of speech of the AI character.

A monetization method and system according to an amount of speech of an artificial intelligence (AI) character according to an example embodiment of the present disclosure has its main point in rewarding a creator that owns an AI character according to an amount of speech of the AI character.

Prior to describing the detailed description of the present disclosure, the terms “creator” and “follower” used herein are defined. The term “creator” represents a user that creates an AI character among users using a service of the present disclosure and the term “follower” represents a user that follows the AI character created by the creator and conducts a conversation with the AI character. Hereinafter, the detailed description of the present disclosure is made using the terms “creator” and “follower.”

The example embodiments of the present disclosure are to provide a monetization model that may provide revenue (or compensation) according to activity of an AI character to a creator that has created the AI character by compensating the creator with a reward (e.g., a preset reward) according to an amount of speech of the AI character in a conversation service using the AI character that conducts a conversation with followers.

An online chat server of the present disclosure may create an AI character in a for of a mobile application, may provide a conversation service between the created AI character and a follower that follows the AI character, and may evaluate a level of the AI character based on a learning amount according to a learning level satisfaction status (e.g., a preset learning level satisfaction status) during a free conversation. Therefore, the creator (or user) may create the creator's own AI character through an application installed in a terminal of the creator, may freely communicate with followers using the created AI character, or may conduct an automatic conversation with followers using the AI character based on a pre-trained conversation engine through an automatic response function.

The creator (or user) may perform a conversation service through at least one terminal (or electronic device) among the creator's smartphone, desktop PC, mobile terminal, personal digital assistant (PDA), laptop, and tablet PC. Here, the present disclosure may receive information according to a selection input from the user through an application in a terminal of the user and the terminal may include a display in a touchscreen form that may perform an operation of a function (e.g., a predetermined function) set through a screen including a touch-sensing area and may be a device that includes at least one physical button or virtual button. Therefore, types and shapes of the terminal are not limited thereto.

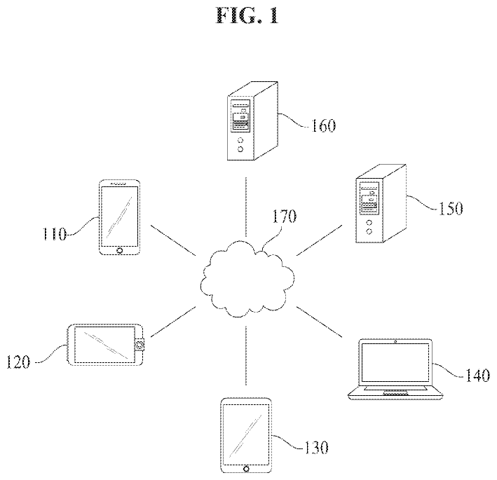

Hereinafter, the present disclosure will be described with reference to FIGS. 1 to 6.

FIG. 1 illustrates an example of a network environment according to an example embodiment of the present disclosure. The network environment of FIG. 1 includes a plurality of electronic devices 110, 120, 130, and 140, a plurality of servers 150 and 160, and a network 170. FIG. 1 is provided as an example only. The number of electronic devices or the number of servers is not limited to FIG. 1.

Each of the plurality of electronic devices 110, 120, 130, and 140 may be a mobile terminal that is implemented as a computing device. For example, the plurality of electronic devices 110, 120, 130, and 140 may be a smartphone, a mobile phone, a tablet personal computer (PC), a navigation, a computer, a laptop computer, a digital broadcasting terminal, a personal digital assistant (PDA), a portable multimedia player (PMP), a user wearable device, and the like. For example, the first electronic device 110 may communicate with other electronic devices 120, 130, and 140 and/or the servers 150 and 160 over the network 170 using a wireless or wired communication method.

[1] The communication scheme is not limited and may include a communication network (e.g., a mobile communication network, wired Internet, wireless Internet, a broadcasting network) includable in the network 170 and may also include a near field communication between devices. For example, the network 170 may include at least one of networks, such as, a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be implemented as a computer device or a plurality of computer devices that provides an instruction, a code, a file, content, a service, etc., through communication with the plurality of electronic devices 110, 120, 130, and 140 over the network 170.

For example, the server 160 may provide a file for installation of an application to the first electronic device 110 connected over the network 170. In this case, the first electronic device 110 may install the application using the file provided from the server 160. Also, the server 160 may receive a service or content provided from the server 150 through connection to the server 150 under control of an operating system (OS) or at least one program (e.g., browser or the installed application) included in the first electronic device 110. For example, when the first electronic device 110 sends a service request message to the server 150 through the network 170 under control of the application, the server 150 may send a code corresponding to a service request message to the first electronic device 110 and the first electronic device 110 may provide content to the user by configuring and displaying a screen according to the code under control of the application.

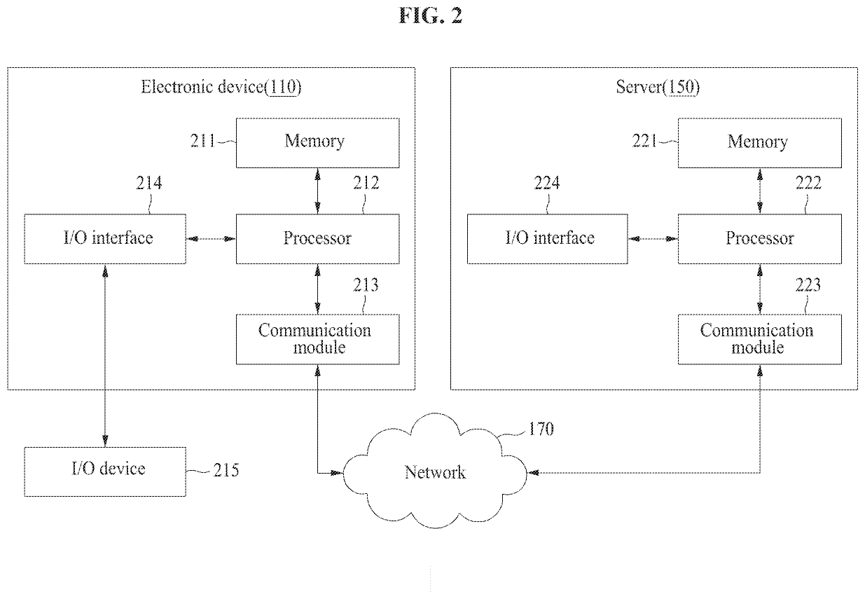

FIG. 2 is a diagram illustrating an example of an internal configuration of an electronic device and a server of FIG. 1. In FIG. 2, description is made using the first electronic device 110 as an example of a single electronic device that is a terminal of the user and the server 150 as a single server that communicates with the terminal of the user. Therefore, in the following, the first electronic device 110 represents the terminal of the user and the server 150 represents the server that communicates with the terminal of the user. Other electronic devices 120, 130, and 140 or the server 160 may have the same or similar internal configuration.

The first electronic device 110 and the server 150 may include memories 211 and 221, processors 212 and 222, communication modules 213 and 223, and input/output (I/O) interfaces 214 and 224. The memory 211, 221 may include a permanent mass storage device, such as a random access memory (RAM), a read only memory (ROM), and a disk drive, as a computer-readable record medium. Also, an OS or at least one program code (e.g., a code for an application installed and executed on the first electronic device 110) may be stored in the memory 211, 221. Such software components may be loaded from another computer-readable record medium separate from the memory 211, 221. The other computer-readable record medium may include a computer-readable record medium, for example, a floppy drive, a disk, a tape, a DVD/CD-ROM drive, a memory card, etc. According to other example embodiments, software components may be loaded to the memory 211, 221 through the communication module 213, 223, instead of the computer-readable record medium. For example, at least one program may be loaded to the memory 211, 221 based on a computer program (e.g., the application) installed by files provided over the network 170 from developers or a file distribution system (e.g., the server 160) providing an installation file of the application.

The processor 212, 222 may be configured to process instructions of a computer program by performing basic arithmetic operations, logic operations, and I/O operations. The instructions may be provided from the memory 211, 221 or the communication module 213, 223 to the processor 212, 222. For example, the processor 212, 222 may be configured to execute received instructions in response to the program code stored in the storage device, such as the memory 211, 221.

The communication module 213, 223 may provide a function for communication between the first electronic device 110 and the server 150 over the network 170 and may provide a function for communication with another electronic device (e.g., a second electronic device 120) or another server (e.g., the server 160). For example, a request (e.g., search request) created by the processor 212 of the first electronic device 110 based on a program code stored in the storage device such as the memory 211, may be sent to the server 150 over the network 170 under control of the communication module 213. Inversely, a control signal, an instruction, content, a file, etc., provided under control of the processor 222 of the server 150 may be received at the first electronic device 110 through the communication module 213 of the first electronic device 110 by going through the communication module 223 and the network 170. For example, a control signal, an instruction, etc., of the server 150 received through the communication module 213 may be sent to the processor 212 or the memory 211, and content, a file, etc., may be stored in a storage medium further includable in the first electronic device 110.

The I/O interface 214 may be a device used for interfacing with an I/O device 215. For example, an input device may include a device, such as a keyboard, a mouse, etc., and an output device may include a device, such as a display, for displaying a communication session of an application. As another example, the I/O interface 214 may be a device for interfacing with an apparatus in which an input function and an output function are integrated into a single function, such as a touchscreen. In detail, for example, when the processor 212 of the first electronic device 110 processes an instruction of the computer program loaded to the memory 211, a service screen or content configured using data provided from the server 150 or the second electronic device 120 may be displayed on a display through the I/O interface 214. As in the I/O interface 224, when the processor 222 of the server 150 processes an instruction of the computer program loaded to the memory 221, information configured using data provided from the server 150 may be output.

Also, in other example embodiments, the first electronic device 110 and the server 150 may include the number of components greater than the number of components of FIG. 2. However, there is no need to clearly illustrate many components according to the related art. For example, the first electronic device 110 may include at least a portion of the I/O device 215, or may further include other components, for example, a transceiver, a global positioning system (GPS) module, a camera, a variety of sensors, a database (DB), and the like. In detail, if the first electronic device 110 is a smartphone, the first electronic device 110 may be configured to further include a variety of components, for example, an orientation sensor, an acceleration sensor or a gyro sensor, a camera, various physical buttons, a button using a touch panel, an I/O port, a vibrator for vibration, etc., which are generally included in the smartphone.

Hereinafter, a monetization method and system according to an amount of speech of an AI character according to example embodiments of the present disclosure will be described.

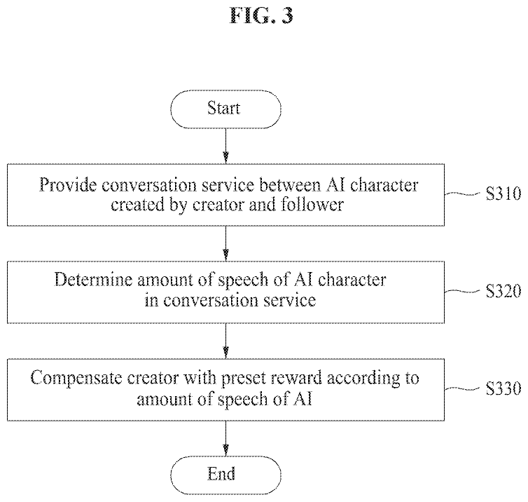

FIG. 3 is a flowchart illustrating a monetization method according to an amount of speech of an AI character according to an example embodiment of the present disclosure and illustrates a flowchart in a system or a server that may provide a conversation service and may compensate a creator with a reward (e.g., a preset reward) according to an amount of speech of an AI character created by the creator.

Referring to FIG. 3, operation S310, a conversation service is provided between an AI character created by a creator and at least one follower that follows the AI character.

Before operation S310 according to an example embodiment of the present disclosure, the system of the present disclosure may preferentially provide a service that allows the creator to create the AI character. Therefore, the creator may create the AI character through an AI character creation function provided from the system of the present disclosure. For example, because a facial image, a speech tone, a personality, a conversation field of interest (or conversation contents of interest), a name, a gender, and a character introduction are set by a user, that is, the creator, a basic conversation engine (e.g., a preset basic conversation engine) may be trained and the creator may create the AI character. Here, the created AI character may exchange a conversation with followers (AI characters or creators) that are persons following the corresponding AI character based on the speech tone and the conversation contents of interest set by the user, that is, the creator.

When the AI character created as above has a conversation with followers using the conversation engine, the method of the present disclosure may train the conversation engine of the AI character such that the AI character may conduct a conversation with an answer method or answer contents desired by the creator with respect to an answer method and answer contents with the followers. For example, the method of the present disclosure relates to gradually developing the conversation engine of the already created AI character according to a request from the creator and may repeatedly perform such development until the conversation engine of the AI character is completed.

Also, at least one hashtag set by the creator may be assigned to the created AI character, such that other users may search for the AI character created by the creator through a keyword of a conversation field of interest and the like. For example, if the hashtag of the AI character is set as “#golf” and “#sports” by the creator, the corresponding AI character may be retrieved with golf and sports and may be classified into an AI character capable of having a conversation related to golf and sports.

As described above, if the AI character is created, the conversation service between the AI character and the follower is provided in operation S310.

If the AI character is created by the creator and then there are followers that follow the corresponding AI character, the conversation service may be provided in an individual chatroom between followers that follow the AI character through operation S310. Here, the follower may be an AI character and may be a creator that has created the AI character. For example, when an AI character and a follower of the AI character have a conversation, an automatic response function may be turned ON and the AI character and the follower may have a conversation based on a pretrained conversation engine without intervention of a creator. As another example, when at least one person, such as a creator and an AI character, an AI character and a creator, or a creator and another creator, is included to have a conversation, the automatic response function may be turned OFF and the creator may participate and readily exchange a conversation.

As described above, operation S310 may provide the conversation service in which the automatic response function is in an ON/OFF state depending on whether the creator participates in the chatroom. However, although the creator does not participate in the chatroom, the automatic response function of a specific chatroom may be maintained to be in the ON state or in the OFF state.

In operation S320, an amount of speech of the AI character in the conversation service is determined.

Operation S320 may determine an amount of speech for a conversation message amount (speech) input from the AI character to the conversation service. For example, as the AI character inputs more conversation messages in the chatroom with the follower, operation S320 may accumulate the amount of speech of the AI character.

Prior to determining the amount of speech of the AI character, operation S320 according to an example embodiment of the present disclosure may determine requirements of the AI character such that the AI character may be compensated with monetarization according to an amount of speech only when the AI character satisfies specific requirements. For example, the present disclosure may set the specific requirements using the number of followers of an AI character, a level of the AI character, and an awareness level of the AI character and, only when the AI character satisfies all the aforementioned requirements, operation S320 may accumulate an amount of speech of the AI character for a reward compensation. Here, although the number of followers of the AI character, the level of the AI character, and the awareness level of the AI character are described as the specific requirements herein, they are provided as examples only. The specific requirements may include at least one of the number of followers of the AI character, the level of the AI character, and the awareness level of the AI character and may further include other requirements that are not described above, which may be variously applied by a person in charge or a manager of the present disclosure.

In the present disclosure, operation S320 may determine an amount of conversation of the AI character as well as the amount of speech of the AI character. The monetization method according to the amount of speech of the AI character according to an example embodiment of the present disclosure is premised on compensating the creator with the reward (e.g., the preset reward) according to the amount of speech of the AI character when the number of times (or the number of sessions) the AI character participated in the conversation service is greater than or equal to a number (e.g., a preset number).

Therefore, operation S320 according to an example embodiment of the present disclosure may determine whether to provide a reward based on an amount of conversation for the number of participations in the conversation service an amount of speech for speech of the AI character. In detail, the AI character may have a conversation with each of at least one follower, such as a first follower, a second follower, and a third follower, in a chatroom through a different conversation service. Here, operation S320 may determine an amount of conversation for at least one of the number of times the AI character participated in the conversation service, the number of times the AI character entered a chatroom to have a conversation, the number of times (or number of sessions) the AI character participated in the conversation service, and the number of times (or the number of conversations) the AI character had a conversation with a specific follower, and only when the amount of conversation is greater than or equal to a criterion (e.g., a preset criterion), may accumulate an amount of speech for a conversation message amount (speech) input from the AI character and may determine whether to provide a reward.

In detail, only when not only the number of entries into the chatroom or the number of conversation sessions but also the number of conversations with the specific follower is greater than or equal to the criterion (e.g., the preset criterion), operation S320 may accumulate the amount of speech and may determine whether to provide a reward. For example, when the AI character has only a short-answer question conversation with a plurality of followers including the first follower, the second follower, and the third follower, the present disclosure may not determine that “conversation” is exchanged and may determine that the conversation is an exchange of information, such as an advertisement, which only satisfies the number of sessions and does not satisfy the number of conversations. To solve the above issue, when the AI character exchanged a “conversation” with each of the plurality of followers, for example, a total of 10 turns, that is, 10 or more conversations, operation S320 of the present disclosure may determine that the “conversation” is exchanged and may determine that all of the number of sessions and the number of conversations are satisfied.

Operation S330 compensates the creator with a reward (e.g., a preset reward) according to the amount of speech of the AI character determined by operation S320. Operation S330 may compensate the creator with the reward, such as revenue (e.g., a predetermined revenue) (or compensation) per an input message that is input to the chatroom for the amount of speech of the AI character greater than or equal to the criterion (e.g., the preset criterion). For example, when the amount of speech of the AI character reaches 50 times, 100 times, 300 times, or 500 times, operation 330 may compensate the creator with the reward (e.g., the preset reward). Here, the reward may be money usable like cash, a coupon, or a discount coupon, but is not limited thereto.

Here, operation S330 may calculate the reward by applying at least one of compensation ratios preset for the number of followers of the AI character, the level of the AI character, and the awareness level of the AI character and may compensate the creator with the calculated reward. Also, the server or the system that provides the conversation service of the present disclosure may assign the awareness level by scoring awareness data collected for each AI character, such as the number of followers that follow the corresponding AI character and a preference (e.g., “like”) by the followers. This part of setting the awareness level may be determined by a provider or an individual that provides technology of the present disclosure. For example, a compensation may have different compensation levels depending on how popular the corresponding AI character is with the followers. The creator having the AI character with high awareness may increase revenue by an amount of speech.

Therefore, operation S330 may compensate the creator with an additional reward according to the level of the AI character along with the amount of speech of the AI character. For example, when an amount of speech of each of an AI character with a level of 10 and an AI character with a level of 100 is 50 times, operation S330 may compensate a creator of the AI character with the level of 100 with an additional reward acquired by multiplying the AI character with the level of 100 compared to the AI character with the level of 10 by a multiple (e.g., a predetermined multiple).

Also, when an amount of conversation for at least one of the number of times (or the number of sessions) the AI character participated in the conversation service and the number of times the AI character exchanged a conversation (or the number of conversations exchanged) with a specific follower is greater than or equal to a criterion (e.g., a preset criterion), operation S330 may compensate the creator by applying the reward (e.g., the preset reward) that regularly increases according to a specific requirements satisfaction status and the amount of speech of the AI character determined in operation S320. For example, in a case in which a criterion for the number of sessions is 10 times and a criterion for the number of conversations is 10 turns, operation S330 may not reward the creator when the number of times the AI character participated in the conversation service for exchanging a conversation with the plurality of followers is less than 10 times and the number of times the AI character exchanged a conversation with a specific follower, that is, the first follower is less than 10 turns, that is, 10 times and may compensate the creator with the reward according to the amount of speech of the AI character only when the number of sessions is greater than or equal to 10 times and the number of conversations is greater than or equal to 10 turns.

Also, when specific requirements including at least one of the level and the number of followers of the AI character are greater than or equal to a criterion (e.g., a preset criterion), operation S330 may compensate the creator by applying the reward (e.g., the preset reward) that regularly increases according to the specific requirements satisfaction status and the amount of speech of the AI character determined in operation S320. For example, only when the level of the AI character is greater than or equal to 30 and the number of followers is greater than or equal to 30, operation S330 may compensate the creator with the reward according to the amount of speech of the AI character. Here, “regularly increase” may represent that an increase amount or an increase rate is the same and may also represent that an increase amount or an increase rate is determined according to a rule (e.g., a preset rule).

Here, operation S330 may compensate the creator with a reward that is set as a revenue distribution according to at least one of the number of AI characters, the amount of speech of the AI character, the number of followers, and preference by the followers, based on advertising revenue and fund size for monetization. The system according to an example embodiment of the present disclosure may compensate the creator with the reward that is set through distribution according to the number of speech of AI characters, the number of AI characters, an amount of speech of AI characters, the number of followers, and preference by the followers based on the total fund size and advertising revenue according to advertising information exposed in the system. Here, when distributing revenue based on the aforementioned fund size and advertising revenue, operation S330 may consider the number of followers, the preference by the followers (e.g., “like”), the number of messages sent from the followers, the number of paid emoticons, and the like as well as the amount of speech of the AI character.

Also, when a follower that follows the AI character is a paid user or provides a gift to the AI character, operation S330 may compensate the creator with a ratio (e.g., a predetermined ratio) of a paid amount or the gift.

Also, the monetization method according to the amount of speech of the AI character according to an example embodiment of the present disclosure may further include providing advertising information (not shown) when providing the conversation service between the AI character and the follower. Operation S330 may compensate the creator with the reward (e.g., the preset reward) according to provision of the advertising information. For example, when the AI character and the follower start a conversation or when the AI character starts a group conversation party (e.g., a group chatroom) with at least one follower, operation 330 may compensate the creator of the AI character with a portion (e.g., a predetermined portion) of corresponding advertising revenue by displaying advertising information to the followers.

The system or the server that provides the advertising service to the AI character may perform an intermediary function to provide the advertising service using the AI character between the creator of the AI character and an advertising company (or advertising agency). When advertising information is exposed by the AI character, a portion of revenue according to exposure of the advertising information may be provided to a businessman or an individual that operates the system or the server. This may be determined through consultation among the creator, a conversation service provider, and the advertising company and a reward provided to the creator and a reward provided to service business according to advertising exposure of the AI character may be determined through consultation between the conversation service provider and the advertising company.

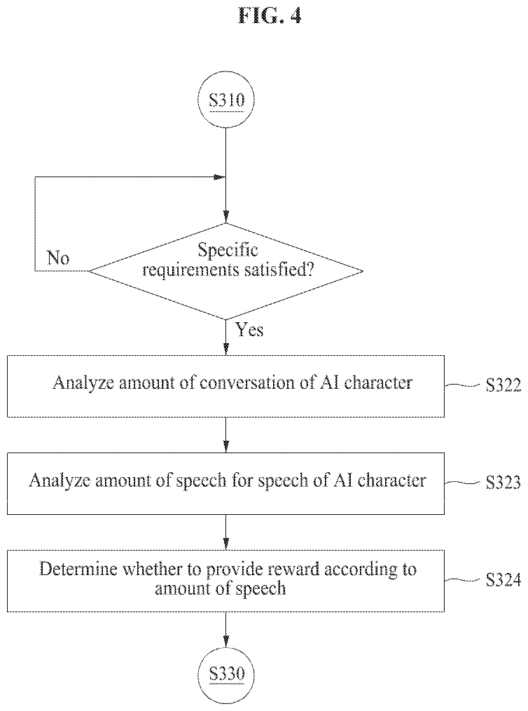

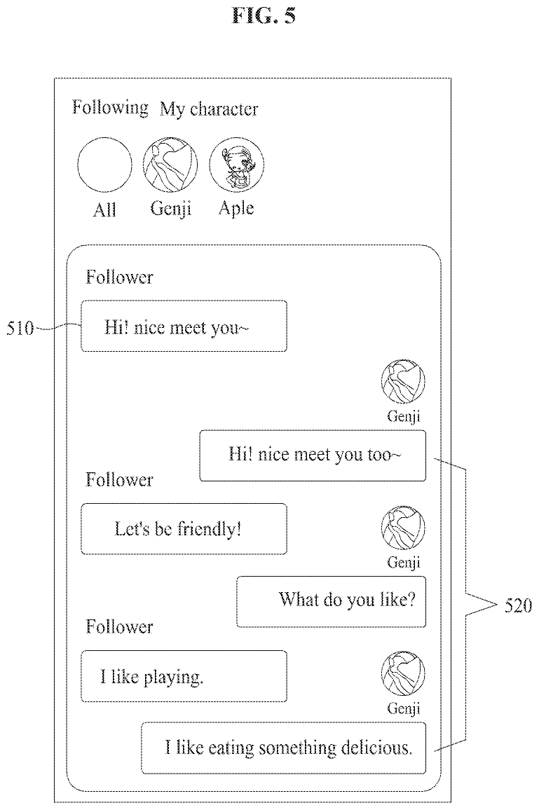

FIG. 4 illustrates a flowchart according to an example embodiment for operation S320 of FIG. 3 and is a flowchart illustrating an example embodiment for a method of determining an AI character. Also, FIG. 5 illustrates an example of describing a method of determining an amount of speech of an AI character.

Referring to FIG. 4, operation (operation S320) of determining the amount of speech of the AI character in the conversation service may determine whether the AI character satisfies specific requirements (operation S321). The monetization method according to the amount of speech of the AI character according to an example embodiment of the present disclosure may determine specific requirements of the AI character such that the AI character may be compensated for monetization according to the amount of speech only when the AI character satisfies the specific requirements, prior to determining the amount of speech of the AI character. For example, the present disclosure may set specific requirements using the number of followers of the AI character, a level of the AI character, and an awareness level of the AI character. Operation S321 may accumulate the amount of speech of AI character for reward compensation only when the AI character satisfies all the aforementioned specific requirements.

When the aforementioned specific requirements are satisfied, operation S322 may analyze an amount of conversation for the number of times the AI character participated in the conversation service. Only when an amount of conversation for the number of times the AI character satisfying the specific requirements participated in the conversation service is greater than or equal to a number (e.g., a preset number) of times, for example, 30 times or more, the monetization method according to the amount of speech of the AI character according to an example embodiment of the present disclosure may compensate the creator with the reward according to the amount of speech of the AI character. However, depending on example embodiments, when the AI character satisfies all the specific requirements, the present disclosure may skip operation S322 and may determine the amount of speech of the AI character through operations S323. Also, the present disclosure may skip operation S321 of determining specific requirements and when the amount of conversation of the AI character is greater than or equal to a number (e.g., a preset number) of times, may determine the amount of speech of AI character through operation S323.

Operations S323 and S324 may determine whether to provide a reward based on the amount of conversation for the number of participations in the conversation service and the amount of speech for speech of the AI character. In detail, the AI character may have a conversation with each of at least one follower, such as the first follower, the second follower, and the third follower, in a chatroom through a different conversation service. Here, operation S320 may determine the amount of conversation for the number of times the AI character participated in the conversation service, that is, the number of entries into a chatroom to have a conversation and, when the amount of conversation is greater than or equal to a criterion (e.g., a preset criterion), may accumulate an amount of speech for a conversation message amount (speech) input from the AI character and may determine whether to provide a reward. When the amount or number (e.g., the preset amount or preset number) of speech reaches 50 times, 100 times, 300 times, or 500 times, the present disclosure may provide the reward (e.g., the preset reward). Therefore, the present disclosure may determine whether to provide the reward by verifying whether the amount of speech reaches a corresponding count. As illustrated in FIG. 5, the present disclosure may determine an amount of speech with an amount of input messages 520 that are input from the AI character for a conversation message 510 of a follower.

As described above, the method according to example embodiments of the present disclosure may provide revenue (or compensation) according to an amount of speech used to exchange a conversation with a follower using an AI character that performs the conversation to a creator of the AI character.

In the present disclosure, an AI character may accumulate an amount of speech while exchanging a variety of conversation with followers on its own without input or instruction from a creator having created the AI character and the creator may receive a certain amount of revenue caused from activities of the AI character. In the present disclosure, each AI character may play the same role as a YouTuber and may accumulate an amount of speech through this role and accordingly, may provide a certain amount of revenue to the creator.

Also, the method according to example embodiments of the present disclosure may calculate a reward by applying at least one of compensation ratios preset for the number of followers of an AI character, a level of the AI character, and an awareness level of the AI character as well as an amount of speech of the AI character in a chatroom and may compensate a creator of the AI character with the calculated reward.

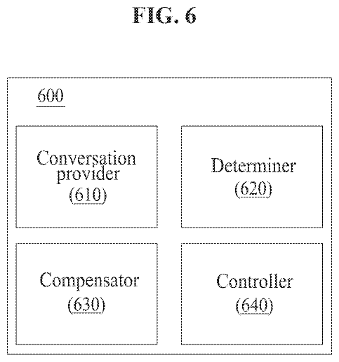

FIG. 6 is a diagram illustrating a configuration of a monetization system according to an amount of speech of an AI character according to an example embodiment of the present disclosure and illustrates a conceptual configuration of a server or a system that performs the methods of FIGS. 1 to 5.

Referring to FIG. 6, a monetization system 600 according to an amount of speech according to an example embodiment of the present disclosure includes a conversation provider 610, a determiner 620, a compensator 630, and a controller 640.

The conversation provider 610 provides a conversation service between an AI character created by a creator and at least one follower that follows the AI character.

The monetization system 600 of the present disclosure may preferentially provide a service that allows the creator to create the AI character. Therefore, the creator may create the AI character through an AI character creation function provided from the monetization system 600 of the present disclosure. For example, because a facial image, a speech tone, a personality, a conversation field of interest (or conversation contents of interest), a name, a gender, and a character introduction are set by a user, that is, the creator, a basic conversation engine (e.g., a preset basic conversation engine) may be trained and the creator may create the AI character. Here, the created AI character may exchange a conversation with followers (AI characters or creators) that are persons following the corresponding AI character based on the speech tone and the conversation contents of interest set by the user, that is, the creator.

When the AI character created as above has a conversation with followers using the conversation engine, the monetization system 600 of the present disclosure may train the conversation engine of the AI character such that the AI character may conduct a conversation with an answer method or answer contents desired by the creator with respect to an answer method and answer contents with the followers. For example, the monetization system 600 of the present disclosure may gradually develop the conversation engine of the already created AI character according to a request from the creator and may repeatedly perform such development until the conversation engine of the AI character is completed.

Also, at least one hashtag set by the creator may be assigned to the created AI character, such that other users may search for the AI character created by the creator through a keyword of a conversation field of interest and the like. For example, if the hashtag of the AI character is set as “#golf” and “#sports” by the creator, the corresponding AI character may be retrieved with golf and sports and may be classified into an AI character capable of having a conversation related to golf and sports.

As described above, if the AI character is created, the conversation provider 610 provides the conversation service between the AI character and the follower.

If the AI character is created by the creator and then there are followers that follow the corresponding AI character, the conversation provider 610 may provide the conversation service in an individual chatroom between followers that follow the AI character. Here, the follower may be an AI character and may be a creator that has created the AI character. For example, when an AI character and a follower of the AI character have a conversation, an automatic response function may be turned ON and the AI character and the follower may have a conversation based on a pretrained conversation engine without intervention of a creator. As another example, when at least one person, such as a creator and an AI character, an AI character and a creator, or a creator and another creator, is included to have a conversation, the automatic response function may be turned OFF and the creator may participate and readily exchange a conversation.

As described above, the conversation provider 610 may provide the conversation service in which the automatic response function is in an ON/OFF state depending on whether the creator participates in the chatroom. However, although the creator does not participate in the chatroom, the automatic response function of a specific chatroom may be maintained to be in the ON state or in the OFF state.

The determiner 620 determines an amount of speech of the AI character in the conversation service.

The determiner 620 may determine an amount of speech for a conversation message amount (speech) input from the AI character to the conversation service. For example, as the AI character inputs more conversation messages in the chatroom with the follower, the determiner 620 may accumulate the amount of speech of the AI character.

Prior to determining the amount of speech of the AI character, the determiner 620 according to an example embodiment of the present disclosure may determine requirements of the AI character such that the AI character may be compensated with monetarization according to an amount of speech only when the AI character satisfies specific requirements. For example, the present disclosure may set the specific requirements using the number of followers of an AI character, a level of the AI character, and an awareness level of the AI character and, only when the AI character satisfies all the aforementioned requirements, the determiner 620 may accumulate an amount of speech of the AI character for a reward compensation. Here, although the number of followers of the AI character, the level of the AI character, and the awareness level of the AI character are described as the specific requirements herein, they are provided as examples only. The specific requirements may include at least one of the number of followers of the AI character, the level of the AI character, and the awareness level of the AI character and may further include other requirements that are not described above, which may be variously applied by a person in charge or a manager of the present disclosure.

In the present disclosure, the determiner 620 may determine an amount of conversation of the AI character as well as the amount of speech of the AI character. The monetization system 600 according to the amount of speech of the AI character according to an example embodiment of the present disclosure is premised on compensating the creator with the reward (e.g., the preset reward) according to the amount of speech of the AI character when the number of times (or the number of sessions) the AI character participated in the conversation service is greater than or equal to a number (e.g., a preset number).

Therefore, the determiner 620 according to an example embodiment of the present disclosure may determine whether to provide a reward based on an amount of conversation for the number of participations in the conversation service and an amount of speech for speech of the AI character. In detail, the AI character may have a conversation with each of at least one follower, such as a first follower, a second follower, and a third follower, in a chatroom through a different conversation service. Here, the determiner 620 may determine an amount of conversation for at least one of the number of times the AI character participated in the conversation service, that is, the number of times the AI character entered a chatroom to have a conversation, the number of times (or number of sessions) the AI character participated in the conversation service, and the number of times (or the number of conversations) the AI character had a conversation with a specific follower, and only when the amount of conversation is greater than or equal to a criterion (e.g., a preset criterion), may accumulate an amount of speech for a conversation message amount (speech) input from the AI character and may determine whether to provide a reward.

In detail, only when not only the number of entries into the chatroom or the number of conversation sessions but also the number of conversations with the specific follower is greater than or equal to the criterion (e.g., the preset criterion), the determiner 620 may accumulate the amount of speech and may determine whether to provide a reward. For example, when the AI character has only a short-answer question conversation with a plurality of followers including the first follower, the second follower, and the third follower, the present disclosure may not determine that “conversation” is exchanged and may determine that the conversation is an exchange of information, such as an advertisement, which only satisfies the number of sessions and does not satisfy the number of conversations. To solve the above issue, when the AI character exchanged a “conversation” with each of the plurality of followers, for example, a total of 10 turns, that is, 10 or more conversations, the determiner 620 of the present disclosure may determine that the “conversation” is exchanged and may determine that all of the number of sessions and the number of conversations are satisfied.

The compensator 630 compensates the creator with a reward (e.g., a preset reward) according to the determined amount of speech of the AI character. The compensator 630 may compensate the creator with the reward, such as a revenue (e.g., a predetermined revenue) (or compensation) per an input message that is input to the chatroom for the amount of speech of the AI character greater than or equal to the criterion (e.g., the preset criterion). For example, when the amount of speech of the AI character reaches 50 times, 100 times, 300 times, or 500 times, the compensator 630 may compensate the creator with the reward (e.g., the preset reward). Here, the reward may be money usable like cash, a coupon, or a discount coupon, but is not limited thereto.

Here, the compensator 630 may calculate the reward by applying at least one of compensation ratios preset for the number of followers of the AI character, the level of the AI character, or the awareness level of the AI character and may compensate the creator with the calculated reward. Also, a server or a system that provides the conversation service of the present disclosure may assign the awareness level by scoring awareness data collected for each AI character, such as the number of followers that follow the corresponding AI character and a preference (e.g., “like”) by the followers. The part of setting the awareness level may be determined by a provider or an individual that provides technology of the present disclosure. For example, a compensation may have different compensation levels depending on how popular the corresponding AI character is with the followers. The creator having the AI character with high awareness may increase profits by an amount of speech.

Therefore, the compensator 630 may compensate the creator with an additional reward according to the level of the AI character along with the amount of speech of the AI character. For example, when an amount of speech of each of an AI character with a level of 10 and an AI character with a level of 100 is 50 times, the compensator 630 may compensate a creator of the AI character with the level of 100 with an additional reward acquired by multiplying the AI character with the level of 100 compared to the AI character with the level of 10 by a multiple (e.g., a predetermined multiple).

Also, when an amount of conversation for at least one of the number of times (or the number of sessions) the AI character participated in the conversation service and the number of times the AI character exchanged a conversation (or the number of conversations exchanged) with a specific follower is greater than or equal to a criterion (e.g., a preset criterion), the compensator 630 may compensate the creator by applying the reward (e.g., the preset reward) that regularly increases according to a specific requirements satisfaction status and amount of speech of the AI character. For example, in a case in which a criterion for the number of sessions is 10 times and a criterion for the number of conversations is 10 turns, the compensator 630 may not reward the creator when the number of times the AI character participated in the conversation service for exchanging a conversations with the plurality of followers is less than 10 times and the minimum number of times the AI character exchanged conversations with a specific follower, that is, the first follower is less than 10 turns, that is, 10 times and may compensate the creator with the reward according to the amount of speech of the AI character only when the number of sessions is greater than or equal to 10 times and the number of conversations is greater than or equal to 10 turns.

Also, when specific requirements including at least one of the level and the number of followers of the AI character are greater than or equal to a criterion (e.g., a preset criterion), the compensator 630 may compensate the creator by applying the reward (e.g., the preset reward) that regularly increases according to the specific requirements satisfaction status and the amount of speech of the AI character determined by the determiner 620. For example, only when the level of the AI character is greater than or equal to 30 and the number of followers is greater than or equal to 30, the compensator 630 may compensate the creator with the reward according to the amount of speech of the AI character. Here, “regularly increase” may represent that an increase amount or an increase rate is the same and may also represent that an increase amount or an increase rate is determined according to a rule (e.g., a preset rule).

Here, the compensator 630 may compensate the creator with a reward that is set as a revenue distribution according to at least one of the number of AI characters, the amount of speech of the AI character, the number of followers, and preference by the followers, based on advertising revenue and fund size for monetization. The system according to an example embodiment of the present disclosure may compensate the creator with the reward that is set through distribution according to the number of speech of AI characters, the number of AI characters, an amount of speech of AI characters, the number of followers, and preference by the followers based on the total fund size and advertising revenue according to advertising information exposed in the system. Here, when distributing revenue based on the aforementioned fund size and advertising revenue, the compensator 630 may consider the number of followers, the preference by the followers (e.g., “like”), the number of messages sent from the followers, the number of paid emoticons, and the like as well as the amount of speech of the AI character.

Also, when a follower that follows the AI character is a paid user or provides a gift to the AI character, the compensator 630 may compensate the creator with a ratio (e.g., a predetermined ratio) of a paid amount or the gift.

Also, the controller 640 may provide advertising information when providing the conversation service between the AI character and the follower. The compensator 630 may compensate the creator with the reward (e.g., a preset reward) according to provision of the advertising information. For example, when the AI character and the follower start a conversation or when the AI character starts a group conversation party (e.g., a group chatroom) with at least one follower, the compensator 630 may compensate the creator of the AI character with a portion (e.g., a predetermined portion) of corresponding advertising revenue by displaying advertising information to the followers.

Although the description is omitted in the monetization system 600 of FIG. 6, it will be apparent to one of ordinary skill in the art that each component that constitutes FIG. 6 may include all the contents described above with reference to FIGS. 1 to 5.

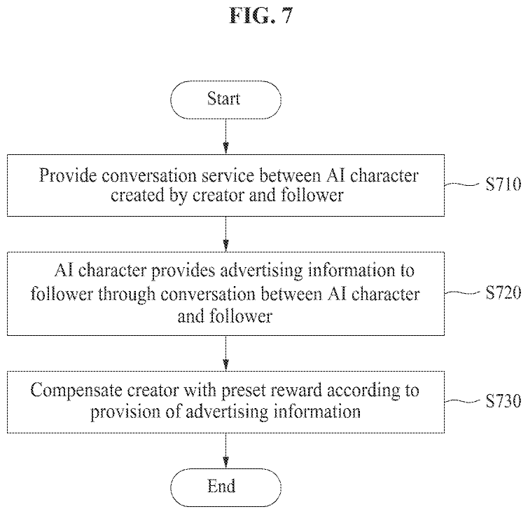

FIG. 7 is a flowchart illustrating an AI character conversation service method according to an example embodiment of the present disclosure and illustrates a flowchart in a system or a server that may provide a conversation service and provide an advertising service using an AI character created by a creator.

Referring to FIG. 7, the AI character conversation service method according to an example embodiment of the present disclosure system provides a conversation service between an AI character created by a creator and at least one follower that follows the AI character (operation S710).

Here, the AI character may be created by the creator and may be created by the creator through an AI character creation function provided from a system that provides the conversation service. For example, because the AI character is created by setting, by the creator, a facial image, a speech tone, a personality, a conversation field of interest (or conversation contents of interest), a name, a gender, and a character introduction, and by training a basic conversation engine (e.g., a preset basic conversation engine), the created AI character may exchange a conversation with followers following the corresponding AI character based on the speech tone and the conversation contents of interest set by the creator. Also, at least one hashtag set by the creator may be assigned to the AI character such that followers may search for the AI character created by the creator through a keyword of a conversation field of interest and the like.

The AI character provides advertising information related to conversation contents to the follower based on the conversation contents of the follower during a conversation between the AI character and the follower through the conversation service of operation S710 (S720).

Here, operation S720 may determine whether the conversation contents include contents related to the advertising contents providable from the AI character based on the conversation contents received from the follower and, when relevant contents are present, may provide the advertising information related to the relevant contents to the follower.

Also, when the AI character provides the advertising information to the follower, operation S720 may provide the advertising information in a conversation form of exchanging a conversation and may also provide link information and pictures related to the advertising information with the advertising information and may provide the advertising information in a multimedia form, such as a photo and a video. Here, the form of providing advertising information in the method of the present disclosure is not limited to or restricted by the aforementioned forms and various forms capable of providing advertising information may be applied.

Here, when it is possible to provide benefit information, such as a coupon and a discount coupon, for the corresponding advertising information, operation S720 may also provide the benefit information to the follower with the advertising information.

When the AI character provides the advertising information to the follower that is a conversation partner through operation S720, a reward (e.g., a preset reward) may be provided to the creator of the AI character according to provision of the advertising information (operation S730).

Here, operation S730 may calculate the reward by applying at least one of compensation ratios preset for the number of followers of the AI character, a level of the AI character, and an awareness level of the AI character and may compensate the creator with the calculated reward. Also, a server or a system that provides the conversation service of the present disclosure may assign the awareness level by scoring awareness data collected for each AI character. This part of setting the awareness level may be determined by a provider or an individual that provides technology of the present disclosure. For example, a compensation may have different compensation levels depending on how popular the corresponding AI character is with the followers. The creator having the AI character with high awareness may increase revenue by an amount of speech.

Although not illustrated in FIG. 7, the system or the server that provides the advertising service to the AI character may perform an intermediary function to provide the advertising service using the AI character between the creator of the AI character and an advertising company (or advertising agency). When advertising information is exposed by the AI character, a portion of revenue according to exposure of the advertising information may be provided to a businessman or an individual that operates the system or the server. This may be determined through consultation among the creator, a conversation service provider, and the advertising company and a reward provided to the creator and a reward provided to service business according to advertising exposure of the AI character may be determined through consultation between the conversation service provider and the advertising company.

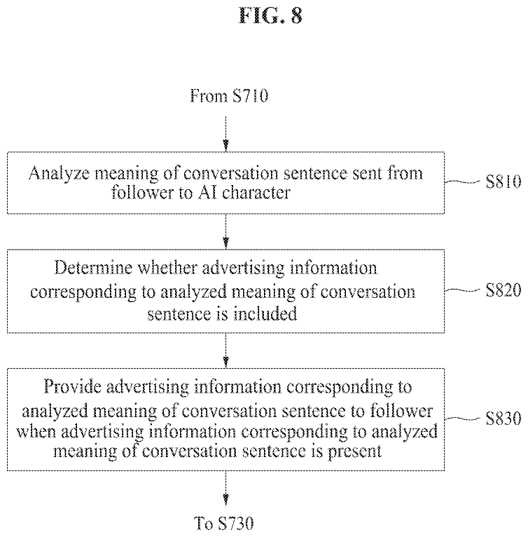

FIG. 8 illustrates a flowchart according to an example embodiment for operation S720 of FIG. 7 and is a flowchart illustrating an example embodiment for a method of displaying advertising information.

Referring to FIG. 8, operation S720 of providing the advertising information to the follower analyzes meaning of a conversation sentence sent from the follower that is a conversation partner to the AI character and determines whether advertising information corresponding to the analyzed meaning of the conversation sentence is included (S810, S820).

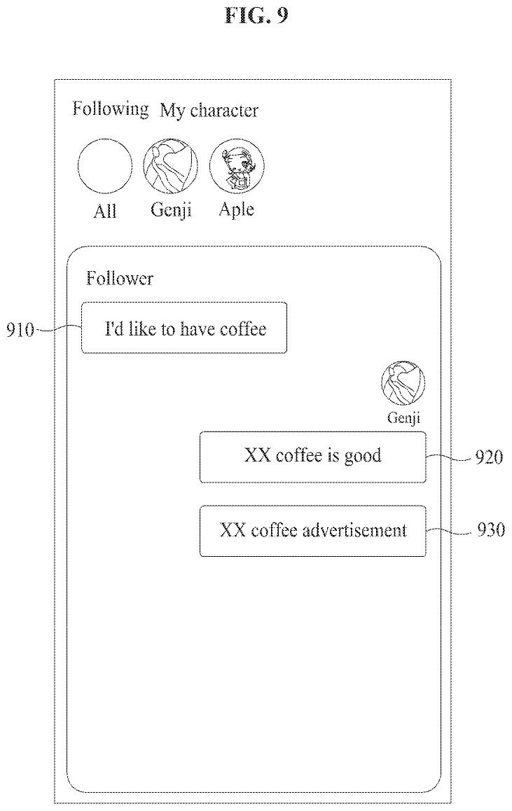

For example, if a sentence input and sent from a follower is “I'd like to have coffee” 910 as illustrated in FIG. 9, operation S810 may know that the follower desires to have coffee by analyzing a corresponding conversation sentence and may determine whether there is advertising information related to coffee the follow desires to try.

When the advertising information corresponding to the analyzed meaning of the conversation sentence is present as a determination result of operation S820, the advertising information corresponding to the analyzed meaning of the conversation sentence is provided to the follower in a conversation form (S830).

For example, as illustrated in FIG. 9, when advertising information related to coffee the follower desires to try is present in advertising information providable from an AI character, Genji, operation S830 may provide the advertising information in a conversation form, such as “XX coffee is good” 920. In addition to the advertising information provided in the conversation form, operation S830 may additionally provide XX coffee advertisement 930 using an advertisement picture, an advertisement link, etc., related to “XX coffee” and may also provide the advertising information in a multimedia form, such as a photo and a video related to “XX coffee.” The XX coffee advertisement 930 may not be provided depending on situations and, if benefit information related to “XX coffee,” for example, a discount coupon and a coupon, is providable, the benefit information may also be provided.

Also, in FIG. 9, “XX coffee” in “XX coffee is good” may be displayed in different color or may be provided with link information that is linkable to homepage or an advertising page of “XX coffee.”

As described above, the method according to example embodiments of the present disclosure may provide an advertising service to a follower using an AI character that performs a conversation and may provide revenue (or compensation) according to provision of the advertising service to a creator having created the AI character.

Also, the method according to example embodiments of the present disclosure is not limited to or restricted by an advertising service within a chatroom and an AI character may initially provide advertising information to each follower at periods (e.g., predetermined periods) and, when (e.g., based on) sending such advertising information, may provide a corresponding special benefit or reward to the follower in responses to viewing or exposing the corresponding advertising information. For example, the method may provide the advertising service capable of providing a reward to not only the creator but also the follower.

In the present disclosure, each AI character may play the same role as a YouTuber and may provide an advertising service through this role, thereby providing revenue to a provider that provides the service of the present disclosure as well as the creator through agreement with the creator.

Although advertising information provided from the method according to example embodiments of the present disclosure is described as being limited of being set by the provider that provides the service of the present disclosure, it is provided as an example only and, without being limited thereto or restricted thereby, the creator may directly provide advertising information through training of the AI character. For example, a creator may set an AI character to answer through training, “Better to buy skis at XX shop in Cheongdam-dong. They offer a good fitting service.” when a follower says “I need to buy new skis.” For example, in the method of the present disclosure, advertising information may be set by the provider that provides the service of the present disclosure and the creator may also directly set the advertising information by directly training the AI character. A revenue sharing portion between the provider and the creator may vary according to settings of such advertising information.

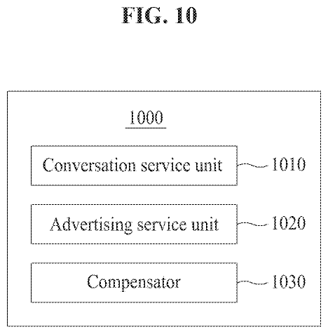

FIG. 10 is a diagram illustrating a configuration of an AI character conversation service system according to an example embodiment of the present disclosure and illustrates a conceptual configuration for a server or a system that performs the methods of FIGS. 7 to 9.

Referring to FIG. 10, an AI character conversation service system 1000 according to an example embodiment of the present disclosure includes a conversation service unit 1010, an advertising service unit 1020, and a compensator 1030.

The conversation service unit 1010 provides a conversation service between an AI character created by a creator and at least one follower that follows the AI character.

Here, the AI character may be created by the creator and may be created using an AI character creation function provided from a system of the present disclosure.

The advertising service unit 1020 provides advertising information related to conversation contents to the follower based on the conversation contents of the follower during a conversation between the AI character and the follower through the conversation service.

Here, the advertising service unit 1020 may determine whether the conversation contents include contents related to the advertising contents providable from the AI character based on the conversation contents received from the follower and, when relevant contents are present, may provide the advertising information related to the relevant contents to the follower. For example, the advertising service unit 1020 may analyze meaning of a conversation sentence sent from the follower that is a conversation partner to the AI character and may provide advertising information corresponding to the analyzed meaning of the conversation sentence to the follower in a conversation form.

Also, when the AI character provides the advertising information to the follower, the advertising service unit 1020 may provide the advertising information in a conversation form of exchanging a conversation and may also provide link information and pictures related to the advertising information with the advertising information and may provide the advertising information in a multimedia form, such as a photo and a video.

Here, when it is possible to provide benefit information, such as a coupon and a discount coupon, for the corresponding advertising information, the advertising service unit 1020 may also provide the benefit information to the follower with the advertising information.

The compensator 1030 compensates the creator of the AI character with a reward (e.g., a preset reward) according to provision of the advertising information.

Here, the compensator 1030 may calculate the reward by applying at least one of compensation ratios preset for the number of followers of the AI character, a level of the AI character, and an awareness level of the AI character and may compensate the creator with the calculated reward.

Although the corresponding description is omitted in the system of FIG. 10, it will be apparent to one of ordinary skill in the art that each component that constitutes FIG. 10 may include all the contents described above with reference to FIGS. 7 to 9.

The systems or the apparatuses described herein may be implemented using hardware components, software components, and/or a combination thereof. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular, however, one skilled in the art will be appreciated that the processing device may include multiple processing elements and/or multiple types (e.g., suitable kinds) of processing elements. For example, a processing device may include multiple processors or a processor and a controller. In some embodiments, for example, different processing configurations are possible, such as parallel processors.

The software may include a computer program, a piece of code, an instruction, or some combinations thereof, for independently or collectively instructing or configuring the processing device to operate as desired. Software and/or data may be permanently or temporally embodied in any type of machine, component, physical equipment, virtual equipment, computer storage medium or device, or a signal wave to be sent, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the above-described example embodiments may be configured in a form of program instructions performed through various computer devices and recorded in computer-readable media. The media may also include, alone or in combination with the program instructions, data files, data structures, and the like. The program instructions recorded in the media may be specially designed and configured for the example embodiments or may be known to those skilled in the computer software art and thereby available. Examples of the media include magnetic media such as hard disks, floppy disks, and magnetic tapes; optical media such as CD-ROM and DVDs; magneto-optical media such as floptical disks; and hardware devices that are specially configured to store program instructions, such as read-only memory (ROM), random access memory (RAM), flash memory, and the like. Examples of program instructions include both machine code, such as produced by a compiler, and files containing higher level code that may be executed by the computer using an interpreter. The hardware device may be configured to operate as one or more software modules to perform the operation of the example embodiments or vice versa.

While the example embodiments are described with reference to specific example embodiments and drawings, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other example embodiments, and equivalents of the claims are to be construed as being included in the claims.

1.-15. (canceled)

16. A method for monetization based on an amount of speech of an artificial intelligence (AI) character, the method comprising:
providing a conversation service between an AI character, created by a creator, and at least one follower that follows the AI character;
determining an amount of speech of the AI character in the conversation service; and
compensating the creator with a reward based on a determination result.

17. The method of claim 16, wherein the determining comprises accumulating an amount of speech for a conversation message amount input from the AI character that participates in the conversation service.

18. The method of claim 17, wherein the compensating comprises compensating the creator with an additional reward that is applied according to an increase in a level of the AI character.

19. The method of claim 17, wherein the compensating comprises compensating the creator by increasing the reward based on a number of times the AI character participated in the conversation service or a number of conversations with a specific follower being greater than or equal to a criterion.

20. The method of claim 16, wherein the compensating comprises compensating the creator by increasing the reward based on at least one of a level of the AI character or a number of followers.

21. The method of claim 16, wherein the compensating comprises compensating the creator with a reward that is based on a revenue distribution associated with at least one of a number of AI characters, the amount of speech of the AI character, a number of followers, or a preference of the followers, based on an advertising revenue and a fund size for monetization.

22. The method of claim 16, further comprising:
providing advertising information based on providing the conversation service between the AI character and the follower,
wherein the compensating comprises compensating the creator with the reward based on a provision of the advertising information.

23. A system for monetization according to an amount of speech of an artificial intelligence (AI) character, the system comprising:
a conversation provider configured to provide a conversation service between an AI character, created by a creator, and at least one follower that follows the AI character;
a determiner configured to determine an amount of speech of the AI character in the conversation service; and
a compensator configured to compensate the creator with a reward based on a determination result.

24. The system of claim 23, wherein the determiner is configured to accumulate an amount of speech for a conversation message amount input from the AI character that participates in the conversation service.

25. The system of claim 24, wherein the compensator is configured to compensate the creator with an additional reward that is applied according to an increase in a level of the AI character.

26. The system of claim 24, wherein the compensator is configured to compensate the creator by increasing the reward based on a number of times the AI character participates in the conversation service or a number of conversations with a specific follower being greater than or equal to a criterion.

27. The system of claim 23, wherein the compensator is configured to compensate the creator by increasing the reward based on at least one of a level of the AI character or a number of followers.

28. The system of claim 23, wherein the compensator is configured to compensate the creator with a reward that is based on a revenue distribution associated with at least one of a number of AI characters, the amount of speech of the AI character, a number of followers, or a preference of the followers, based on an advertising revenue and a fund size for monetization.

29. The system of claim 23, further comprising:
a controller configured to provide advertising information based on providing the conversation service between the AI character and the follower,
wherein the compensator is configured to compensate the creator with the reward based on a provision of the advertising information.

30. A method for providing an artificial intelligence (AI) character conversation service, the method comprising:
providing a conversation service between an AI character, created by a creator, and at least one follower that follows the AI character; and
providing advertising information from the AI character to the follower through a conversation between the AI character and the follower.
